(19) United States
(12) Patent Application Publication
(10) Pub. No.: US 2026/0203560 A1
(43) Pub. Date: Jul. 16, 2026

(54) ENHANCED CAPABILITIES FOR SOPHISTICATED TIME SERIES FORECASTING AND UNCERTAINTY MODELING

(71) Applicant: Schlumberger Technology Corporation, Sugar Land, TX (US)

(72) Inventors: Sunil Manikani, Pune (IN); Gayatri Farma Novenita, Pune (IN); Venkatesh Srinivasan, Pune (IN); Gian-Marcio Gey, London (GB); Abbi Moghaiyera Hassan, Houston, TX (US)

(21) Appl. No.: 19/449,607

(22) Filed: Jan. 15, 2026

Related U.S. Application Data
(60) Provisional application No. 63/745,407, filed on Jan. 15, 2025.

(51) Int. Cl. G06N 3/0475; G06N 3/08

(52) U.S. Cl. CPC G06N 3/0475; G06N 3/08

(57) ABSTRACT

A method implements enhanced capabilities for sophisticated time series forecasting and uncertainty modeling. The method involves mapping a set of columns of a dataset to a set of hierarchical trees. The method further involves training a machine learning model using the dataset and the set of hierarchical trees to predict one or more target columns of the set of columns. The method further involves sampling the machine learning model to generate multiple predictions for the one or more target columns. The method further involves presenting the multiple predictions.

### CROSS REFERENCE TO RELATED APPLICATIONS

This application claims the benefit of the U.S. Provisional Application 63/745,407, filed on Jan. 15, 2025, which is hereby incorporated by reference in its entirety.

### BACKGROUND

Machine learning models include algorithms that identify patterns in data and generate predictive outputs. These models operate through iterative optimization processes that adjust parameters based on input data to improve accuracy. Applications of machine learning span diverse domains such as image recognition, natural language processing, and anomaly detection.

Forecasting and modeling generates predictions for time series data. For example, in the context of greenhouse gas emissions, the forecasting and modeling involve analyzing sequential measurements to predict future emission levels. Techniques incorporate statistical methods and machine learning approaches to capture temporal dependencies and variability. Accurate projections assist in evaluating mitigation strategies and assessing environmental impact.

### SUMMARY

In general, in one or more aspects, the disclosure relates to a method for enhanced capabilities for sophisticated time series forecasting and uncertainty modeling. The method involves mapping a set of columns of a dataset to a set of hierarchical trees. The method further involves training a machine learning model using the dataset and the set of hierarchical trees to predict one or more target columns of the set of columns. The method further involves sampling the machine learning model to generate multiple predictions for the one or more target columns. The method further involves presenting the multiple predictions.

In general, in one or more aspects, the disclosure relates to a system that includes a computer processor and an application that executes on the computer processor. Executing the application performs mapping a set of columns of a dataset to a set of hierarchical trees. Executing the application further performs training a machine learning model using the dataset and the set of hierarchical trees to predict one or more target columns of the set of columns. Executing the application further performs sampling the machine learning model to generate multiple predictions for the one or more target columns. Executing the application further performs presenting the multiple predictions.

In general, in one or more aspects, the disclosure relates to a non-transitory computer readable medium including instructions executable by at least one processor. Executing the instructions performs mapping a set of columns of a dataset to a set of hierarchical trees. Executing the instructions further performs training a machine learning model using the dataset and the set of hierarchical trees to predict one or more target columns of the set of columns. Executing the instructions further performs sampling the machine learning model to generate multiple predictions for the one or more target columns. Executing the instructions further performs presenting the multiple predictions.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, and FIG. 5 show examples in accordance with the disclosure.

FIG. 6.1 and 6.2 show computing systems in accordance with the disclosure.

Similar elements in the various figures may be denoted by similar names and reference numerals. The details of features and elements described in one figure may extend to similarly named features and elements in different figures.

### DETAILED DESCRIPTION

Embodiments of the disclosure relate to advanced forecasting and modeling for greenhouse gas emissions using machine learning techniques. A structured framework may be used that combines multivariate time series forecasting, hierarchical aggregation, and uncertainty quantification. The system incorporates physics-informed neural networks and explainable artificial intelligence to generate accurate predictions across multiple horizons and organizational levels.

Machine learning models applied to greenhouse gas emissions forecasting may encounter limitations. Existing approaches may struggle with long horizon predictions, hierarchical reconciliation, and integration of physical constraints. Emissions data may exhibit temporal dependencies and structural breaks, making it difficult for standard models to maintain accuracy over extended horizons. Hierarchical reconciliation may be complicated by inconsistent data granularity across sectors and regions, which introduces aggregation bias. Physical constraints, such as energy balance or carbon cycle dynamics, may not be accounted for in statistical models, leading to physically implausible forecasts. Scalability across multivariate and hierarchical datasets may be challenging due to computational complexity and memory limitations, especially when integrating high-dimensional climate and socioeconomic variables. Explainability may be limited because deep learning and ensemble methods may operate as black boxes, reducing trust in predictions and hindering policy adoption.

Embodiments of the disclosure address the limitations through a hybrid architecture that integrates physics-informed machine learning models. The system models aleatoric and/or epistemic uncertainties using quantile-based estimation and Monte Carlo sampling. Hierarchical reconciliation is incorporated directly into the machine learning model architecture, producing aggregated outputs without inflated uncertainty bands. The framework supports parallel forecasting of multiple time series and aligns emissions trajectories with climate pathways, improving accuracy and transparency for long term sustainability planning. An emissions spiral visualization transforms predictions of forecasted greenhouse gas data into a radial representation, highlighting seasonal patterns and long-term trends for intuitive interpretation.

In one embodiment, a set of columns of a dataset is mapped to a set of hierarchical trees, thereby defining parent-child relationships used for reconciliation at each aggregation level. The model is trained using the dataset together with the hierarchical trees to predict a designated target column, ensuring that bottom-up and top-down constraints are respected during learning. The trained model is then sampled via Monte Carlo procedures to generate a plurality of predictions for the target column, with each sample capturing both aleatoric and/or epistemic effects through quantile-based estimation. The plurality of predictions is presented to the user, including uncertainty intervals and hierarchy-consistent aggregates, via dashboards and the emissions spiral visualization to enable intuitive, multi-level interpretation.

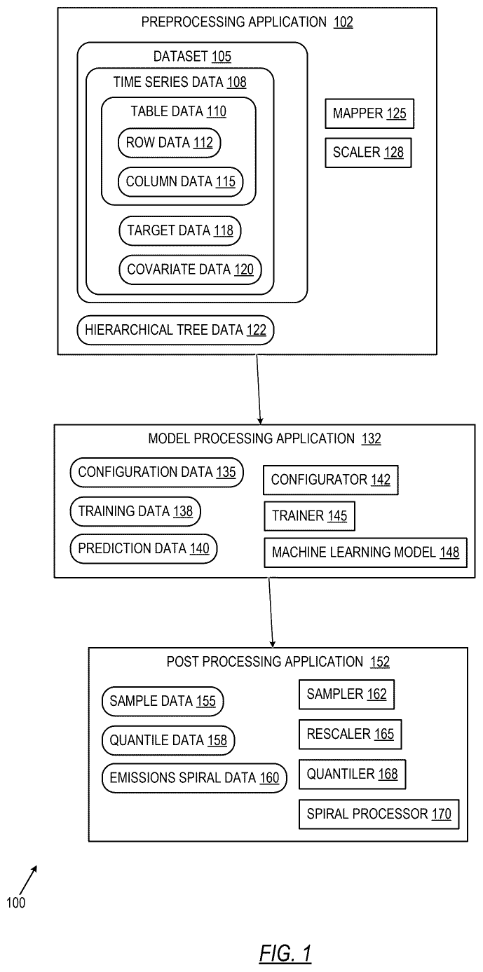

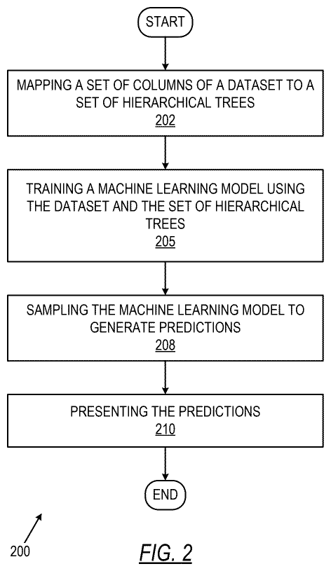

Turning to FIG. 1, the system (100) is an integrated computing environment that orchestrates the preprocessing application (102), the model processing application (132), and the post processing application (152) for greenhouse gas forecasting workflows. The system (100) includes data repositories, processing modules, and visualization components that exchange structured datasets such as the dataset (105) and derived outputs such as predictions stored in the prediction data (140). The system (100) is used to coordinate data flow across applications, apply the machine learning model (148) to the time series data (108), and produce interpretive artifacts such as the emissions spiral data (160).

The preprocessing application (102) is an application that ingests the dataset (105) and prepares structured inputs for downstream modeling. The preprocessing application (102) performs schema validation, feature construction, and normalization using the table data (110) and the column data (115) and generates hierarchical trees stored in the hierarchical tree data (122) and scaled data processed by the scaler (128). The preprocessing application (102) is used to establish standardized inputs that reflect relationships among the column data (115) and quantitative ranges suitable for training.

The dataset (105) is a structured collection of records and fields representing time indexed measurements and descriptors. As an example, the dataset (105) may quantify values such as greenhouse gas emissions per month and production volumes per facility, for example metric tons of Carbon Dioxide (CO₂) equivalent reported by site and period. The dataset (105) is used as the source for the time series data (108), the target data (118), and the covariate data (120) that are input to the trainer (145).

The time series data (108) is a subset of the dataset (105) organized as chronological sequences for one or more variables. The time series data (108) quantifies temporal evolution such as monthly emissions values and operational metrics observed across consecutive periods (i.e., time periods). The time series data (108) may represent intervals such as hourly, daily, weekly, monthly, quarterly, yearly, or decennial, measurements. The time series data (108) is used to construct inputs for autoregressive modeling and to track patterns for forecasting and uncertainty estimation.

The table data (110) is a tabular representation of the time series data (108) with the row data (112) for periods and the column data (115) for variables and nodes of the hierarchical tree data (122). The table data (110) quantifies associations including totals and logical unit values aligned by dates. For example a table may include columns for organization, region east, region west, and production rate. The table data (110) is used as input to the mapper (125) and the scaler (128) and to preserve alignment between the target data (118) and the covariate data (120).

The row data (112) is a per period record extracted from the table data (110). The row data (112) quantifies values observed at a specific timestamp, such as emissions in March 2025 and production in March 2025. The row data (112) is used to form sequential inputs for training and prediction windows processed by the trainer (145). Each row corresponds to a discrete time step within the time series, representing a single point in the chronological sequence used for forecasting across the forecast horizon. The forecast horizon represents the span of future time steps for which predictions are generated, for example, a range extending from one month ahead to multiple decades ahead.

The column data (115) is a per variable field extracted from the table data (110). The column data (115) quantifies a variable (e.g., CO₂ equivalent emissions for region east across multiple periods) or a future covariate (e.g., planned production capacity). The column data (115) is used by the mapper (125) to derive the hierarchical tree data (122) and by the scaler (128) to apply transformations per series. The column data (115) may include headers that specify hierarchical relationships among variables, such as labels indicating totals, regional divisions, and sub-unit identifiers used to construct hierarchical trees of the hierarchical tree data (122). The headers include structural context for mapping parent-child relationships that define reconciliation logic during model training and are recorded in the hierarchical tree data (122).

The target data (118) is a set of time series designated for prediction. The target data (118) may be represented as one more target columns in the column data (115) of the table data (110). The target data (118) quantifies emission values such as emissions per month and region-specific emissions per month. The target data (118) is used to define outputs of the machine learning model (148) and to evaluate accuracy, uncertainty, and hierarchical uniformity during processing by the trainer (145).

The covariate data (120) is a set of time series associated with the target data (118). The covariate data (120) may be represented as one more covariate columns in the column data (115) of the table data (110). Some of the covariate columns may represent future covariates. The covariate data (120) quantifies explanatory factors such as production rate, energy mix, maintenance schedules, and calendar attributes (e.g., a holiday indicator for December periods). A covariate is an independent variable that can influence the output of a dependent variable (e.g., the target data). The covariate data (120) may include past covariates and future covariates, both of which may be used to condition the machine learning model (148) and improve long-horizon forecasts generated by the prediction data (140). Past covariates represent historical variables observed prior to the forecast horizon, such as prior production levels and historical temperature readings. Future covariates represent variables with known or planned values during the forecast horizon, such as scheduled maintenance activities or projected production targets defined by operational plans.

The hierarchical tree data (122) is a graph structure representing parent-child relationships among the column data (115) and aggregations. The hierarchical tree data (122) quantifies aggregation rules such as organization equals region east plus region west plus region north plus region south, and nested sub-unit sums under each region. The hierarchical tree data (122) includes hierarchical trees that aggregate and organize nodes into levels reflecting organizational or geographic hierarchies, where each tree defines child node contributions to parent totals. For example, a hierarchical tree may have a parent node (“organization total”) with two child nodes (“region east” and “region west”) that indicates an “organization total” column of a table is the sum of the “region east” and “region west” columns of the table. Hierarchical trees include a structured representation for reconciliation logic, so that predictions for individual nodes align with aggregated outputs across multiple hierarchical levels during model training and inference. The hierarchical tree data (122) is used to guide reconciliation during training and to produce aggregated predictions processed by the trainer (145).

The mapper (125) is a processing component that transforms the column data (115) into the hierarchical tree data (122). The mapper (125) receives the table data (110) and the column data (115), identifies relationships defined by configuration data (135), and generates the hierarchical tree data (122) with nodes and edges. The nodes represent entities such as totals, regional divisions, and sub-units, while the edges represent parent-child relationships that define aggregation paths between nodes. The mapper (125) constructs hierarchical trees by linking nodes through edges to reflect hierarchical structures recorded in headers of the column data (115). The mapper (125) is used to supply structural inputs to the model processing application (132) that reflects aggregation logic for multi-level forecasting.

The scaler (128) is a transformation component that applies scaling to numeric series prior to training. The scaler (128) receives the time series data (108), computes parameters, such as minimum and maximum per series, and outputs scaled data suitable for numerical stability and optimization. The scaler also supplies parameters for rescaling predictions processed by the rescaler (165). As an example, the scaler (128) may normalize values on a scale of 0 to 1 to standardize magnitudes across different variables and improve training performance. The scaler (128) is used to normalize magnitudes across the target data (118) and the covariate data (120), improving training convergence and interpretability of inverse transformed outputs.

The model processing application (132) is an application that executes machine learning operations, which may be for greenhouse gas forecasting. The model processing application (132) receives structured inputs such as the hierarchical tree data (122), the scaled time series data (108), and the configuration data (135), and produces outputs including the prediction data (140). The model processing application (132) is used to apply training algorithms, generate forecasts, and maintain consistency across hierarchical levels defined by the hierarchical trees.

The configuration data (135) is a dataset that defines parameters and settings for the machine learning model. The configuration data (135) quantifies attributes such as input chunk length, output chunk length, number of encoder layers, and quantile specifications for uncertainty estimation. The configuration data (135) is used by the configurator (142) to initialize the model architecture and by the trainer (145) to apply training procedures aligned with forecasting objectives.

The training data (138) is a processed dataset derived from the time series data (108), the target data (118), and the covariate data (120) after scaling and hierarchical mapping. The training data (138) quantifies historical sequences and associated covariates across multiple time steps, for example emissions values from prior years combined with production metrics and calendar indicators. The training data (138) is used by the trainer (145) to optimize model weights and improve predictive accuracy across the forecast horizon.

The prediction data (140) is a dataset generated by the machine learning model after inference. The prediction data (140) quantifies forecasted values for the target data (118) across future time steps, for example projected emissions for each region over the next decade with associated uncertainty intervals. The prediction data (140) includes predictions for the forecast horizon and may represent future time steps for long-range planning and sustainability analysis. The prediction data (140) is used as input to the post processing application (152) for sampling, quantile computation, and visualization in the emissions spiral data (160).

The configurator (142) is a processing component that applies the configuration data (135) to initialize the machine learning model. The configurator (142) receives architecture parameters and optimization settings, constructs the model structure, and outputs a configured model ready for training. The configurator (142) is used to control the computational framework for the trainer (145) to process the training data (138).

The trainer (145) is a processing component that executes the training procedure for the machine learning model. The trainer (145) receives the training data (138), applies iterative optimization using loss functions, and updates model weights to minimize prediction error. The trainer (145) is used to produce a trained model that generates the prediction data (140) while maintaining consistency with the hierarchy defined by the hierarchical tree data (122).

The machine learning model (148) is a predictive model that processes multivariate time series data combined with hierarchical tree structures and covariate information to generate long-horizon forecasts. The machine learning model (148) may be implemented as a time-series dense encoder (TiDE) model, which is a time series dense encoder architecture used for sequential data forecasting. The model incorporates encoder and decoder layers, reversible instance normalization, and quantile regression to estimate uncertainty across forecast horizons. The machine learning model (148) is trained using the training data (138) under the control of the trainer (145) and optimized through iterative weight updates based on loss functions that account for hierarchical reconciliation and covariate influence. After training, the machine learning model (148) produces the prediction data (140) and is subsequently used by the post processing application (152) for sampling, quantile computation, and visualization, including generation of emissions spiral data (160) for interpretive analysis.

The post processing application (152) is an application layer that performs operations on outputs generated by the model processing application (132). The post processing application (152) receives the prediction data (140) and produces derived datasets such as the sample data (155), the quantile data (158), and the emissions spiral data (160). The post processing application (152) is used to refine predictions, compute uncertainty measures including aleatoric and/or epistemic uncertainties, and generate visual representations for interpretive analysis.

The sample data (155) is a dataset generated by applying sampling techniques to the prediction data (140). The sample data (155) quantifies multiple simulated outcomes for each forecasted time step, for example one hundred sampled trajectories of emissions values across the forecast horizon. The sample data (155) is used to estimate variability and to compute probabilistic bounds for uncertainty quantification covering both aleatoric uncertainty related to inherent data variability and/or epistemic uncertainty related to model assumptions.

The quantile data (158) is a dataset derived from the sample data (155) by calculating quantile values across sampled predictions. The quantile data (158) quantifies statistical intervals such as the fifth percentile, median, and ninety-fifth percentile for each forecasted time step, for example emissions projections with upper and lower confidence limits. The quantile data (158) is used to present uncertainty ranges that reflect aleatoric and/or epistemic uncertainty components and to inform visualization in the emissions spiral data (160).

The emissions spiral data (160) is a dataset that represents forecasted values in a radial coordinate system projected onto a three-dimensional coordinate system. A spiral representation may be applied to a time-indexed dataset to convey cyclical patterns and long-term progression in a compact spatial format. Radial coordinates may represent periodic intervals, vertical axes may represent cumulative progression, and color gradients may encode magnitude or uncertainty. The spiral representation may display visualizations for domains involving seasonality, trend analysis, or multi-year planning beyond emissions forecasting. The emissions spiral data (160) quantifies temporal progression by mapping time steps to angular positions and predicted emissions magnitudes to radial distances, and in an example, the year may correspond to a z-axis, the month may correspond to the angular position, and the radial distance may correspond to the emissions value. The emissions spiral data (160) is used to provide a visualization of long-term trends and seasonal variations in greenhouse gas emissions across multiple years.

The sampler (162) is a processing component that generates the sample data (155) from the prediction data (140). The sampler (162) applies stochastic methods such as Monte Carlo simulation to produce multiple prediction realizations and outputs the sample data (155) for subsequent quantile computation. The sampler (162) is used to model uncertainty and variability in emissions forecasts across the forecast horizon by generating samples that capture aleatoric and/or epistemic uncertainty characteristics.

The rescaler (165) is a processing component that applies inverse transformations to the prediction data (140) and the sample data (155). The rescaler (165) receives scaling parameters computed by the scaler (128) and restores forecasted values to the original measurement scale, for example converting normalized emissions values back to metric tons of CO₂ equivalent. The rescaler (165) is used to produce interpretable outputs for visualization and reporting.

The quantiler (168) is a processing component that computes the quantile data (158) from the sample data (155). The quantiler (168) calculates percentile-based intervals for each forecasted time step and outputs structured quantile data (158) for uncertainty visualization. The quantiler (168) is used to summarize probabilistic information including quantile intervals that represent aleatoric and/or epistemic uncertainty and to prepare data for graphical representation in the emissions spiral data (160).

The spiral processor (170) is a processing component that transforms the prediction data (140) and the quantile data (158) into the emissions spiral data (160) using a radial coordinate system projected onto a three-dimensional coordinate system. The spiral processor (170) maps time steps to angular coordinates, predicted values to radial distances, and assigns a vertical axis for year progression, for example using the z-axis for years, the angle for months, and the radial distance for emissions magnitude. The spiral processor (170) may apply color coding for uncertainty bands and output a radial visualization dataset that conveys both long-term trends and variability in greenhouse gas forecasts.

FIG. 2 shows a flowchart of a method for enhanced capabilities for sophisticated time series forecasting and uncertainty modeling. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the method (200) generates predictions from a dataset and hierarchical trees using a machine learning model. The process (200) may include multiple steps (e.g., Block 202 through Block 210) that may execute on the components described in the other figures, including those of FIG. 1, FIG. 7.1, and FIG. 7.2.

Block 202 involves mapping a set of columns of a dataset to a set of hierarchical trees. A mapper component parses table data headers and column identifiers to create hierarchical tree data, which may include nodes for totals, regions, sub-units, and covariate series, and edges that encode parent-child relationships. Aggregation rules are recorded in the hierarchical tree data, for example, an organizational total equals region east plus region west plus region north plus region south, with deeper nesting for sub-units. Additionally, logical units, such as exploration, production, drilling, and mining, and physical geographic units, such as Europe and Middle East Asia, may be mapped to tree structures to preserve multi-level relationships. Disconnected covariate series without hierarchical affiliation are registered as independent nodes to retain alignment with time-indexed rows and forecast windows. Independent nodes are not linked to any parent node within the aggregation tree and may exist as a standalone node in the graph structure. Reconciliation metadata may capture reconciliation strategy options, such as top-to-bottom, bottom-to-top, or midpoint adjustments, may be recorded and attached to the tree for downstream modeling stages.

The method (200) may involve marking a multiple covariate series of multiple time series of the dataset by identifying and labeling the multiple covariate series for training the machine learning model. Past covariate series are labeled for variables observed historically such as production rate measurements and temperature readings that influence target sequences autoregressively. Future covariate series are labeled for variables with planned or known values over the forecast horizon such as monthly production targets, maintenance schedules, and calendar indicators including holiday flags. Static covariate series are labeled for attributes that remain constant across time such as site category, technology class, or region code to condition model features without temporal variation. Label data records the association between covariate series and target series, frequency settings, horizon length, and alignment rules used during configuration and training. Marked covariate series are grouped by role as past, future, and static, and stored with versioned schema descriptors to maintain reproducibility for backtesting and comparative validation.

The method (200) may involve mapping the set of columns of the dataset, in which the set of hierarchical trees define aggregations of the columns. Column headers and hierarchy tags are translated into hierarchical trees that specify parent totals, child contributions, and nested rollups across organizational and geographic levels. Tree construction captures structures used for hierarchical reconciliation, so aggregated outputs avoid naive variance inflation during multi-level summation. Reconciliation metadata may reflect a top-to-bottom strategy with options for bottom-to-top and midpoint strategies compatible with deterministic post-hoc methods or integrated neural layers. Mapped trees include identifiers for each node, edge weights where applicable, and references to corresponding dataset columns for traceability from raw inputs to aggregated predictions. Validation procedures verify tree integrity against sample periods and reference totals before proceeding to configuration and training stages.

The method (200) may involve scaling the dataset with a transformation. Feature scaling applies a MinMaxScaler across target series and covariate series to normalize magnitudes into the range zero to one for stable optimization. Scaling parameters such as per-series minima and maxima are computed and stored to support inverse transformation during post processing of predictions and samples. Optional reversible instance normalization is recorded in configuration data to adapt scaling behavior for long-horizon sequences and multivariate inputs. Scaled datasets are segmented into training and validation windows based on client-selected backtesting periods and forecast horizons to prepare inputs for subsequent modeling operations. Rescaling artifacts, such as parameter snapshots and schema hashes, are persisted with dataset lineage information to maintain continuity across sampling, aggregating, and emissions visualization stages.

Block 205 involves training a machine learning model using the dataset and the set of hierarchical trees to predict one or more target columns of the set of columns. Training may apply iterative optimization to adjust model weights using backpropagation across encoder and decoder layers of a TiDE architecture. The training process consumes scaled time series data, hierarchical tree data, and covariate series to learn dependencies among target variables and hierarchical aggregations. Loss functions incorporate penalties for hierarchical reconciliation and prediction error across multiple horizons. The training procedure executes multiple epochs with dynamic learning rate scheduling and early stopping criteria to improve convergence. Checkpointing logic is integrated to preserve intermediate states for recovery and model selection.

Unlike a purely rule-based hierarchy, which enforces deterministic aggregation, the proposed approach actively integrates hierarchical trees with scaled time series data during training to learn nuanced, nonlinear dependencies across levels. As an example, the training process feeds both the scaled time series and hierarchical tree representations into the TiDE encoder-decoder architecture for gradient-based optimization to propagate signals across hierarchy levels. Backpropagation adjusts weights to capture cross-level signals and nonlinear relationships, while reconciliation penalties in the loss function enforce hierarchical consistency without rigid rules. Scaling ensures numerical comparability across levels so that reconciliation matrices remain stable during optimization. Through iterative epochs, the model learns how influence flows between levels rather than applying static aggregation, resulting in predictions that adapt to noise, structural shifts, and complex dependencies—capabilities that deterministic rule-based methods cannot provide.

The method (200) may involve configuring the machine learning model. Configuration applies architecture parameters such as input chunk length, output chunk length, number of encoder layers, number of decoder layers, and hidden dimensions. Quantile regression settings are specified for uncertainty estimation across forecast intervals. Normalization options such as reversible instance normalization are applied to stabilize training for multivariate sequences. Batch size and learning rate scheduler parameters are defined to control optimization dynamics. Configuration data is loaded into the configurator to instantiate the machine learning model prior to training.

The method (200) may involve training the machine learning model to predict a target value using past covariate data and future covariate data. The past covariate data may include multiple past covariate columns and the future covariate data may include multiple future covariate columns. Past covariate sequences, such as historical production metrics and temperature readings, are aligned with target series to form autoregressive inputs. Future covariate sequences, such as planned production targets and scheduled maintenance indicators, are integrated into the forecast horizon to condition predictions. The model fuses target history, past covariates, and future covariates into a latent representation processed by dense encoder layers. Decoder layers generate multi-step outputs for each target series while maintaining alignment with hierarchical constraints. Monte Carlo dropout or sampling techniques may be applied during training to improve accuracy and uncertainty modeling.

The method (200) may involve saving a checkpoint of the machine learning model. Checkpointing stores model weights and optimizer states after selected epochs for recovery and evaluation. In-memory checkpointing is applied to reduce latency compared to disk-based storage, improving throughput for large-scale training. Two-pass checkpointing logic is implemented to capture optimal states without frequent disk writes, reducing bottlenecks during extended training runs. Checkpoint metadata may include epoch index, validation loss, and configuration hash for reproducibility. Saved checkpoints are referenced during backtesting and model deployment to restore trained states for inference.

Block 208 involves sampling the machine learning model to generate predictions for the target columns. Sampling applies stochastic techniques such as Monte Carlo simulation to produce multiple prediction realizations for each forecasted time step. The sampling process generates a configurable number of samples (i.e., predictions), for example, one hundred samples, to capture variability and uncertainty in emissions forecasts. Sampled outputs are stored as structured datasets for subsequent quantile computation and visualization. Sampling may incorporate aleatoric and/or epistemic uncertainty components by varying model parameters and dropout states during inference.

Each sample may be generated by providing the model with a structured input that includes historical target sequences, aligned past covariate sequences, and planned future covariate sequences for the forecast horizon, along with node identifiers from the hierarchical tree to maintain aggregation context. The model processes the input to produce predicted values for the target variable across the specified time steps. The forecast horizon corresponds to the output chunk length defined during model configuration, and the input chunk length determines the span of historical data included in the structured input.

The method (200) may involve rescaling the predictions with an inverse transformation of the transformation. Inverse transformation restores normalized predictions to the original measurement scale using parameters recorded during initial scaling. Rescaling applies stored minima and maxima for each series to convert values from the zero-to-one range back to units such as metric tons of CO₂ equivalent. The rescaling process is executed for both deterministic predictions and sampled outputs to maintain interpretability. Rescaled predictions may be validated against reference ranges to confirm alignment with historical magnitudes before visualization.

The method (200) may involve aggregating the predictions to generate quantile data, which may help in deducing aleatoric and/or epistemic uncertainty. Quantile computation aggregates sampled predictions to calculate percentile-based intervals such as fifth percentile, median, and ninety-fifth percentile. Quantile data represents uncertainty bounds for each forecasted time step and is structured for integration into visualization components. The aggregating process applies statistical functions across sample distributions to derive prediction intervals for long-horizon forecasts. Quantile datasets may be stored with quantile metadata including forecast horizon, quantile levels, and associated target series identifiers.

Block 210 involves presenting the predictions. Presentation renders forecasted values in graphical and tabular formats for interpretive analysis and decision-making. Visual outputs include line charts with confidence bands derived from quantile data and hierarchical aggregation views for organizational levels. Presentation components apply color coding and annotations to distinguish predicted trajectories, uncertainty intervals, and reconciliation states. Rendered outputs may be exported to reporting modules and dashboards for sustainability planning and compliance monitoring.

The method (200) may involve presenting the predictions using the quantile data. Quantile data is integrated into visualization layers to display uncertainty bands around predicted trajectories. Confidence intervals are represented as shaded regions or color gradients to convey variability across forecast horizons. Presentation logic aligns quantile intervals with hierarchical structures to maintain clarity for aggregated and disaggregated views. Outputs include interactive charts that allow exploration of percentile ranges for emissions forecasts across multiple organizational units.

The method (200) may involve generating an emissions spiral by processing the predictions. The emissions spiral transforms forecasted values into a radial coordinate system projected onto a three-dimensional axis. As an example, angular positions represent months, radial distances represent emissions magnitudes, and vertical positions represent years to visualize temporal progression. Processing applies scaling adjustments and color coding to highlight seasonal patterns and long-term trends in emissions trajectories. The emissions spiral dataset is prepared for rendering in visualization engines supporting polar and cylindrical projections.

The method (200) may involve presenting the predictions using the emissions spiral. Presentation displays the emissions spiral as an interactive or static visualization for intuitive interpretation of forecasted emissions. The spiral view may portray cyclical variations and cumulative trends across decades, aiding assessment of climate pathway alignment. Color gradients and annotations may indicate uncertainty bands and target milestones such as net-zero objectives. Rendered spirals are integrated into dashboards and exported for reporting in sustainability and compliance contexts.

The method (200) may involve backtesting the machine learning model. Backtesting compares forecasted values against historical data withheld during training to evaluate predictive accuracy. The process overlays predicted trajectories with actual observations for selected validation periods to assess performance metrics. Error measures such as mean absolute error and coverage of prediction intervals are computed to quantify reliability. Backtesting results are recorded with configuration identifiers and used to refine model parameters or validate readiness for deployment.

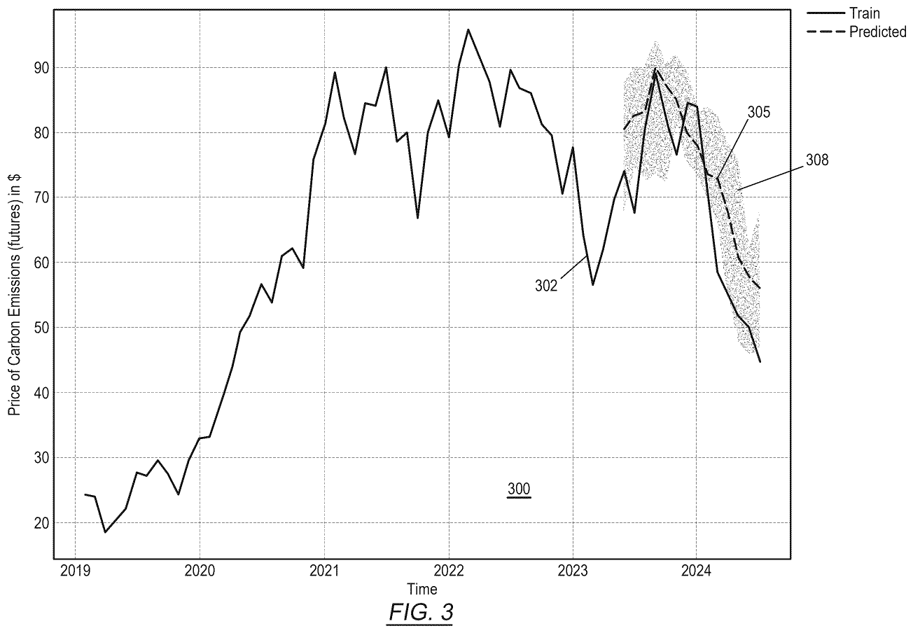

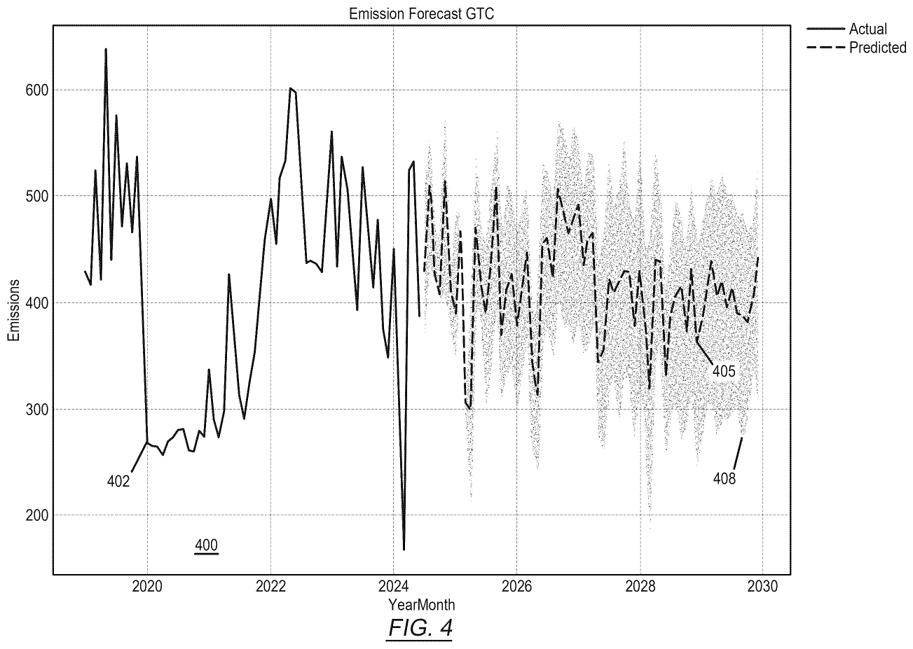

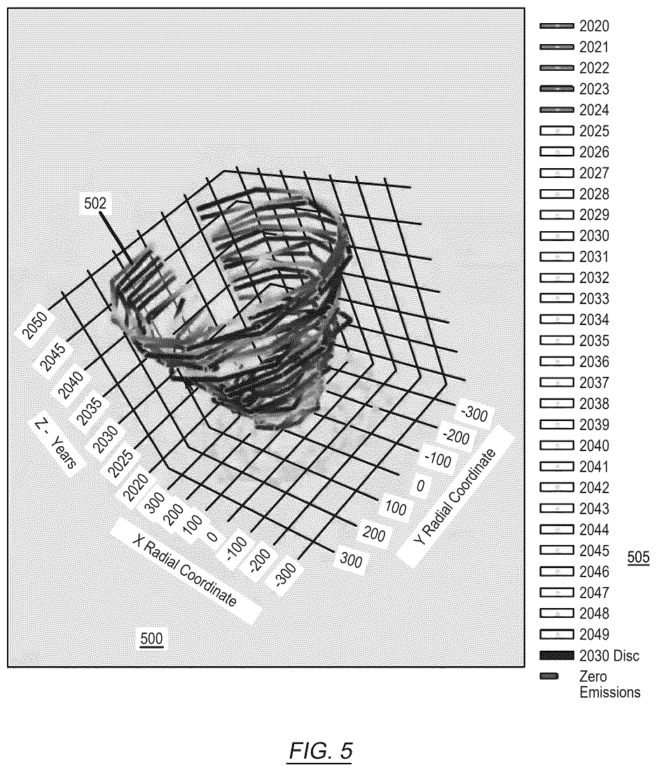

Turning to FIG. 3, the graph (300) may be displayed on a computer and shows a time series chart comparing historical data and forecasted predictions for the price of carbon emissions futures in dollars. The line (302) (which may be colored black) represents the training data, which corresponds to observed historical values, while the line (305) (which may be colored blue) and shaded region (308) represent predicted values and associated uncertainty intervals generated by the machine learning model. The shaded region (308) illustrates confidence ranges derived from quantile computation and Monte Carlo sampling.

The graph (300) demonstrates the backtesting process by overlaying predicted trajectories on actual historical data withheld during training. Backtesting validates model accuracy by comparing forecasted values against known observations for a selected period, for assessment of prediction reliability and uncertainty coverage before long-horizon forecasting is applied.

Turning to FIG. 4, the graph (400) may be displayed on a computer and shows a time series visualization of greenhouse gas emissions for an organizational unit, combining historical observations and forecasted predictions. The line (402) (which may be colored black) represents actual emissions data collected over previous years, while the line (405) (which may be colored blue) represents predicted emissions values generated by the machine learning model. The shaded region (408) surrounding the line (405) illustrates uncertainty intervals derived from quantile computation and Monte Carlo Simulation, indicating variability in long-horizon forecasts. The intervals may correspond to percentiles such as p10 and p90, providing optimistic and pessimistic bounds for users to make informed decisions.

The visualization demonstrates the transition from historical data to future projections, highlighting extension of the forecasting model extends predictions beyond the last observed point. The forecast horizon spans multiple years, and the uncertainty band portrayed by the shaded region (408) widens as the timeline progresses, reflecting increasing uncertainty in long-term predictions. The graph (400) is a representation that presents the capability of the model to incorporate hierarchical structures and covariate influences while maintaining probabilistic outputs for interpretive analysis.

Turning to FIG. 5, the graph (500) may be displayed on a computer and shows a three-dimensional visualization of forecasted greenhouse gas emissions represented as an emissions spiral. The spiral (502) is constructed using radial coordinates projected onto a cylindrical grid, where angular positions correspond to months, radial distances (from the center of the spiral) represent emission magnitudes, and the vertical axis represents progression across years. Multiple colored lines form concentric loops stacked upward in the spiral (502), indicating temporal evolution from early years at the base to later years at the top of the spiral. The legend (505) associates each line with a specific year, ranging from 2020 through 2049, along with markers for 2030 discontinuity and zero-emission targets.

The graph (500) presents long-horizon forecasts in an intuitive format that highlights seasonal cycles and cumulative trends over decades. The radial coordinate system displays periodicity within each year, while the three-dimensional projection conveys growth or reduction patterns across extended time frames. Color gradients and structural layering illustrate uncertainty and variability in emissions trajectories to assess alignment with climate goals such as net-zero targets. The graph (500) is a representation that transforms tabular predictions into an interpretive spatial model that supports sustainability planning and compliance analysis.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

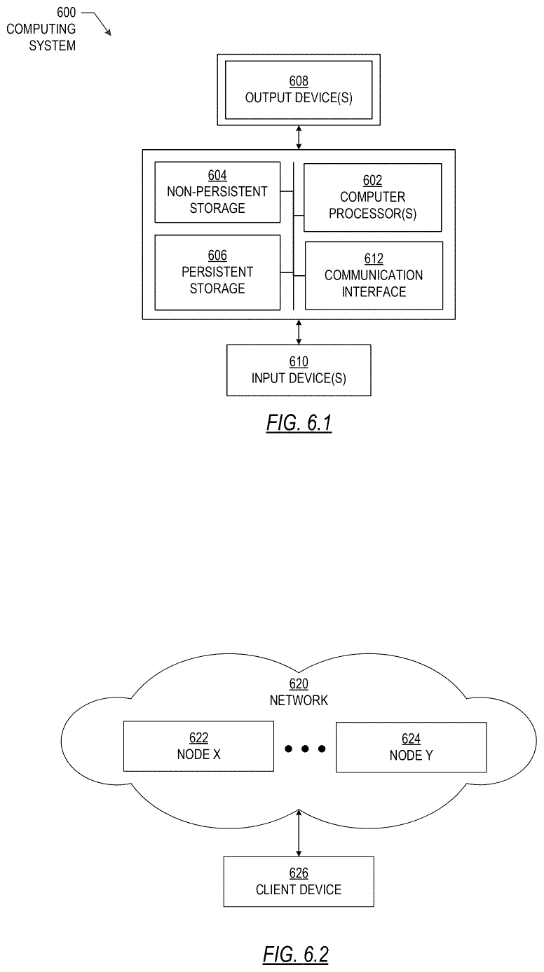

For example, as shown in FIG. 6.1, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN), such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6.1 may be connected to, or be a part of, a network. For example, as shown in FIG. 6.2, the network (620) may include multiple nodes (e.g., node X (622) and node Y (624), as well as extant intervening nodes between node X (622) and node Y (624)). Each node may correspond to a computing system, such as the computing system shown in FIG. 6.1, or a group of nodes combined may correspond to the computing system shown in FIG. 6.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6.1. Further, the client device (626) may include or perform all or a portion of one or more embodiments.

The computing system of FIG. 6.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and”, unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
mapping a set of columns of a dataset to a set of hierarchical trees;
training a machine learning model using the dataset and the set of hierarchical trees to predict one or more target columns of the set of columns;
sampling the machine learning model to generate a plurality of predictions for the one or more target columns; and
presenting the plurality of predictions.

2. The method of claim 1, further comprising:
generating an emissions spiral by processing the plurality of predictions; and
presenting the plurality of predictions using the emissions spiral.

3. The method of claim 1, further comprising:
marking a plurality of covariate series of a plurality of time series of the dataset by identifying and labeling the plurality of covariate series for training the machine learning model.

4. The method of claim 1, further comprising:
mapping the set of columns of the dataset, wherein the set of hierarchical trees define aggregations of the columns.

5. The method of claim 1, further comprising:
scaling the dataset with a transformation; and
rescaling the plurality of predictions with an inverse transformation of the transformation.

6. The method of claim 1, further comprising:
configuring the machine learning model.

7. The method of claim 1, further comprising:
training the machine learning model to predict a target value using past covariate data and future covariate data.

8. The method of claim 1, further comprising:
saving a checkpoint of the machine learning model.

9. The method of claim 1, further comprising:
aggregating the plurality of predictions to generate quantile data; and
presenting the plurality of predictions using the quantile data.

10. The method of claim 1, further comprising:
backtesting the machine learning model.

11. A system comprising:
a computer processor; and
an application that, when executing on the computer processor, performs operations comprising:
mapping a set of columns of a dataset to a set of hierarchical trees,
training a machine learning model using the dataset and the set of hierarchical trees to predict one or more target columns of the set of columns,
sampling the machine learning model to generate a plurality of predictions for the one or more target columns, and
presenting the plurality of predictions.

12. The system of claim 11, wherein the application performs operations further comprising:
generating an emissions spiral by processing the plurality of predictions; and
presenting the plurality of predictions using the emissions spiral.

13. The system of claim 11, wherein the application performs operations further comprising:
marking a plurality of covariate series of a plurality of time series of the dataset by identifying and labeling the plurality of covariate series for training the machine learning model.

14. The system of claim 11, wherein the application performs operations further comprising:
mapping the set of columns of the dataset, wherein the set of hierarchical trees define aggregations of the columns.

15. The system of claim 11, wherein the application performs operations further comprising:
scaling the dataset with a transformation; and
rescaling the plurality of predictions with an inverse transformation of the transformation.

16. The system of claim 11, wherein the application performs operations further comprising:
configuring the machine learning model.

17. The system of claim 11, wherein the application performs operations further comprising:
training the machine learning model to predict a target value using past covariate data and future covariate data.

18. The system of claim 11, wherein the application performs operations further comprising:
saving a checkpoint of the machine learning model.

19. The system of claim 11, wherein the application performs operations further comprising:
aggregating the plurality of predictions to generate quantile data; and
presenting the plurality of predictions using the quantile data.

20. A non-transitory computer readable medium comprising instructions executable by a computer processor to perform:
mapping a set of columns of a dataset to a set of hierarchical trees to predict one or more target columns of the set of columns;
training a machine learning model using the dataset and the set of hierarchical trees;
sampling the machine learning model to generate a plurality of predictions for the one or more target columns; and
presenting the plurality of predictions.
